(19) United States
(12) Patent Application Publication
(10) Pub. No.: US 2016/0044203 A1
(43) Pub. Date: Feb. 11, 2016

(54) Electronic Ticket Transfer

(71) Applicants: Brooke Paul, Powell, OH (US); Craig Smith, Seattle, WA (US); Eric Kerr, Chicago, IL (US); Tanisha Robinson, Columbus, OH (US)

(72) Inventors: Brooke Paul, Powell, OH (US); Craig Smith, Seattle, WA (US); Eric Kerr, Chicago, IL (US); Tanisha Robinson, Columbus, OH (US)

(21) Appl. No.: 14/749,988

(22) Filed: Jun. 25, 2015

Related U.S. Application Data
(60) Provisional application No. 62/034,947, filed on Aug. 8, 2014.

(51) Int. Cl. H04N 1/04; H04N 1/00; G06Q 10/02

(52) U.S. Cl. CPC H04N 1/04; G06Q 10/02; H04N 1/001

(57) ABSTRACT

A method to electronically capture, digitize, mobilize and transfer a paper ticket for use as an entry to a venue over a computer network.

### CROSS REFERENCE TO RELATED APPLICATION

This application claims priority to U.S. Provisional Application No. 62/034,947, filed Aug. 8, 2014, the entirety of which is incorporated herein by reference.

### TECHNICAL FIELD

The present invention relates generally to electronic capture, digitization, mobilization and transfer of a ticket to a venue over a computer network and to the temporary electronic storage of information and data regarding the ticket.

### BACKGROUND

Tickets for venues, such as recreational or leisure events, tournaments, sporting events, music concerts, theater shows, conventions and exhibitions are typically sold by the venue hosting the event. Resale of tickets requires that the tickets are somehow transferred from the owner to another person. Transferring tickets to another person is sometimes a problem. Most venues require a physical or PDF printed ticket. Ticket transfer today is done via email or post.

Problems exist with transferring physical tickets, especially in the final minutes/hours before an event. Transfers may not be secure or easily accomplished. Confirming that a transfer has been made to a third party can be difficult, and fans can become frustrated when tickets are not in their hands as the event nears.

Paper tickets can be lost by the owner or in the mail. Transferring paper tickets at an event is problematic in trying to meet the person in a crowd to exchange tickets with another person across town or on the opposite side of the arena. For season ticket holders, paper tickets must be stored in a secure location that is remembered and easy to access for each event. Transferring paper tickets by mail can incur costly overnight shipping fees. Transferring PDF tickets by email is more efficient, but still requires that the ticket be printed. This limits the time window for using the ticket, as it is difficult for most ticket holders to print tickets within the hour(s) before an event begins.

Another problem exist when users attempting to list tickets for sale in other systems receive an error when entering the bar code. Transferred tickets are sometimes unused because transferees are not properly notified.

A need exists for a method to efficiently, conveniently and securely transfer venue tickets in real-time. A need exists for a system to enhance the confidence level of the validity and accuracy of an electronic image of a paper ticket. A need exists for a system to confirm that the transferee received the ticket. A need exists for a method to eliminate the use of paper tickets by using an easy to use application to store and display admission codes on a portable device.

### SUMMARY OF THE INVENTION

The present invention provides a method for easily and securely transferring a digitalized version of a paper, electronic, PDF or photo of a ticket between parties in real-time. The present invention provides a method for the transfer of tickets where the owner receives confirmation of the transfer of the ticket.

The advantages of the invention over present systems are that it allows ticket owners to transfer tickets easily, conveniently and reliably. A further advantage is that tickets may be transferred to another person the day of the event, minutes before the event, or even after the event has started. Season tickets can be digitized for security and convenience. The present invention allows for the transferring of tickets to another person across town, the opposite side of the venue, or across the globe. The present invention eliminates shipping costs by moving tickets digitally across town or across the world, rather than shipping the physical ticket(s). The present invention allows for the transfer of a ticket even after the event has begun.

The invention is a method of creating a digital version of a paper ticket. The paper ticket may be a single use, multiple use, season ticket, and the like. In operation, a controller connected to a network, such as the Internet, receives information from a user using a computing device connected to the network. The information is input by the user using the computing device in response to prompts generated by the controller. The information comprises an event title, a venue, a date, a section and a seat. The information further comprises a photo of the paper ticket and a scan of a barcode of the paper ticket. The photo and the scan are captured by the computing device and uploaded to the controller.

The controller processes the information, photo and scan. In an embodiment, the processing comprises using a unique optical character recognition (OCR) technology to create a result for each of the title of the event, venue, price, date, time, section row and seat and determining a confidence level for the OCR results. If the confidence level meets or exceeds a required confidence level, the OCR results are combined with the barcode and the ticket is digitized to create a mobile ticket. In an embodiment, the required confidence level is about 60% to about 100%. In an alternate embodiment, the required confidence level is at least about 80% to about 95%. In a preferred embodiment, the required confidence level is 90%. If the confidence level is less than the required confidence level), the photo and the OCR results are reviewed manually, errors are corrected and the digital ticket is created. Where errors cannot be corrected, a request to reimage the paper ticket is generated and transmitted to the user's computing device. In an embodiment, the method is performed using a mobile application and a smartphone. In an embodiment, the digital ticket comprises a barcode and an animation that indicates whether the ticket is useable. In an embodiment, the animation is discontinued after the digital ticket is used for the event, whether that is single, multiple, season tickets, and the like In an embodiment, the digital ticket is stored on the user's computing device.

The method further comprising transferring a digital ticket to a transferee. In an embodiment, the controller prompts the user to input contact information, such as a mobile phone number, an email address, an electronic ID and the like, linked to or accessible on, a second computing device, for a designated transferee. Upon receipt of the contact information, the controller generates an electronic message to the transferee via the contact information. The message comprising a claim code, information about application and information about the ticket. The message further comprises instructions for inputting the claim code at the application. Upon receipt of a claim code that matches a digital ticket to be transferred, the controller electronically transfers the claimed digital ticket via the contact information, which is stored in a file on the second computing device.

As used herein, the term “about” is meant to include +/−10% of the value. Terms such as “top,” “bottom,” “right,” “left,” “above”, “under”, “side” “front”, “below” “upper”, “back” and the like, are words of convenience and are not to be construed as limiting.

The compositions and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range or to be limited to the exact conversion to a different measuring system, such, but not limited to, as between inches and millimeters.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### BRIEF DESCRIPTION OF THE DRAWINGS

FIG. 1 is a flow diagram of the method of the invention.

FIG. 2 is flow diagram of an exemplary method of processing ticket images.

FIG. 3 is a screen shot of an embodiment of the invention.

FIG. 4 is an example of a ticket.

FIGS. 5-11 are screen shots depicting an embodiment of the invention.

### DETAILED DESCRIPTION OF THE INVENTION

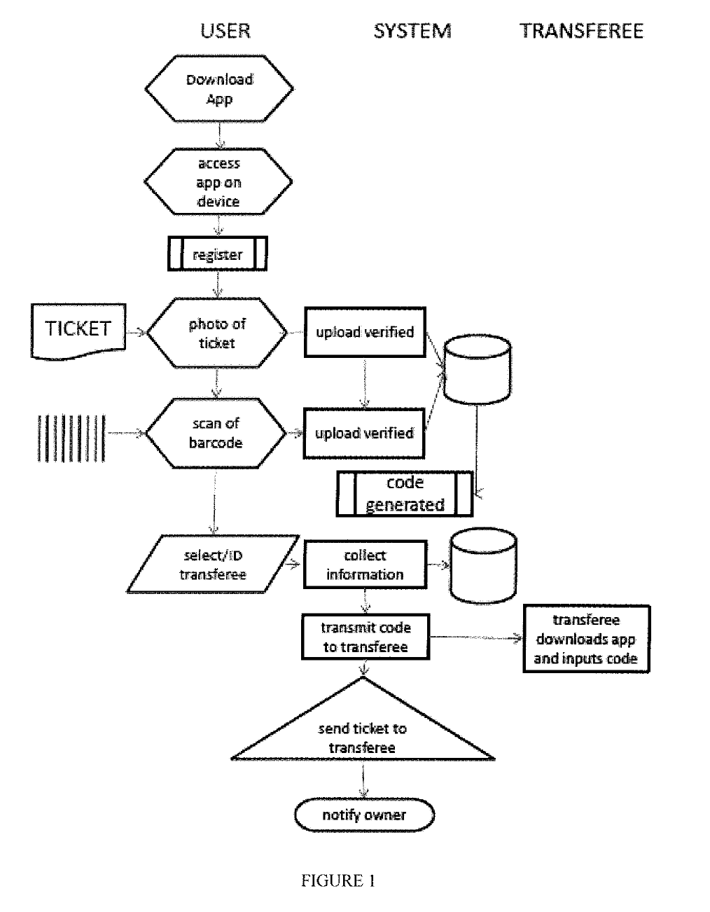

In accordance with the present invention, a method of transferring a ticket in a digital form is illustrated in FIG. 1. In an embodiment, a user with a paper, pdf, electronic or a photo of a ticket to a venue accesses a system 10 with a device 20. The system comprises a central controller, processor or computer 100 that facilitates the transfer of the ticket to a transferee. The controller comprises executable instruction, such as computer code, stored in a memory. The instructions generate the processes, including but not limited to screen prompts, graphic interfaces, messaging, data storage and the like. The device is in communication with the controller. In an embodiment, the device is in communication with the controller via the Internet. In an embodiment the device is a communication device, computer, tablet, smartphone (iPhone (Apple, Inc.), Android (Google, Inc., etc.)), a kiosk and the like. In an exemplary embodiment, the user downloads a mobile application to the user's smart phone. The smart phone includes an image device, such as a camera that can generate a frame to scan an object for optical character recognition (OCR), a speech recognition device, global positioning system (GPS) or other location device, and the like.

In an embodiment, the user inputs information, such as a username, phone number, address, email, password and the like into the system using the app. The system stores the information in a database. In an exemplary embodiment, the user after downloading the mobile application, registers electronically by inputting information to establish an account. Alternatively, Likewise, the mobile application prompts the user to access a social network or other third party systems to obtain personal information.

One or more tickets to an event may be electronically transferred. The ticket is a ticket issued by the venue, a reseller, a printed PDF ticket, and the like. The ticket to a venue or event, such as a sporting event, concert, play, presentation, and the like. The event can be a single event or multiple events, such as season tickets or multiple passes. A ticket can be for a single use or a season-ticket or multiple entry pass, such as season football, hockey and soccer games and tennis, racing and golf matches.

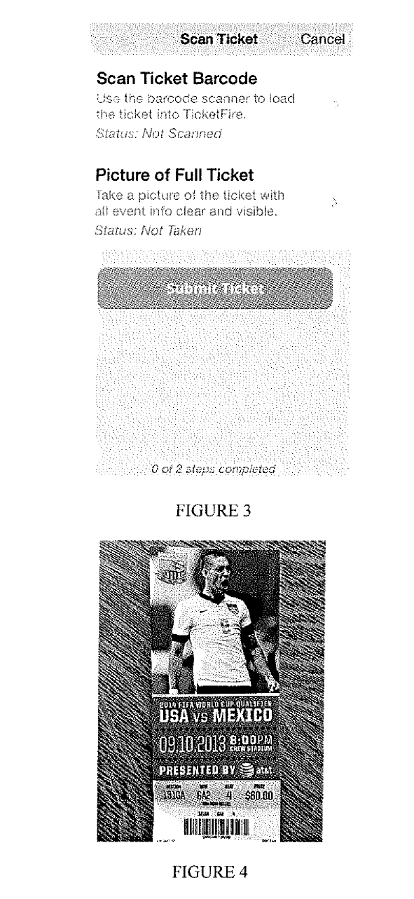

In an exemplary embodiment depicted in FIGS. 3-8, the user uses the mobile app to create an electronic ticket. The user selects “Scan” or clicks a sign on a screen of the app on the device to input information to the controller. The information comprises a title of the event, venue, date, section, seat and the like. As depicted in FIG. 3, the mobile app prompts the user/ticket holder to scan the bar code of the paper ticket and take a photo of the ticket. The user takes a photo of the ticket (FIG. 4) when prompted by the system and scans the barcode of the ticket when prompted by the system. The barcode can be a one-dimensional bar code, two-dimensional QR code, 2-dimensional matrix code, hologram, 3D barcode, color code, image code, combination code and the like. Optionally, the barcode may be scanned as part of a one-step capture process from the photo of the ticket.

The system comprises data identification and data capture algorithms and technologies, such as a proprietary optical character recognition (OCR) system, speech recognition systems, decoders and the like. The OCR technology is used to detect symbols during the scan of the paper ticket, such as alphabets (including English, Chinese, Japanese, Cyrillic, Greek, Hebrew, Arabic, Farsi and the like) as well as other symbols (such as special characters, punctuation marks, math symbols, alphabet-modified characters, monetary symbols and the like). The system prompts the user to select a character string, such as the title of the event, venue, date, time, price section, row, seat, etc.

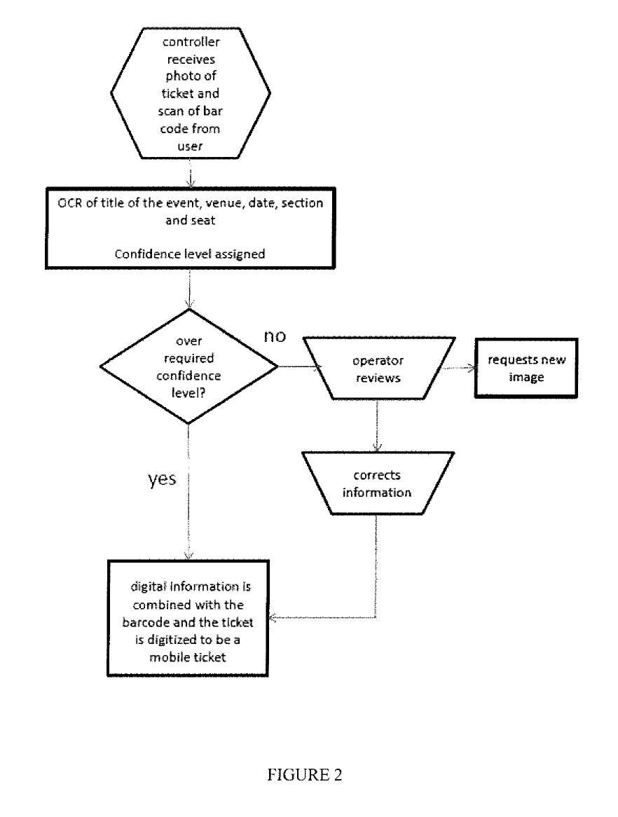

With reference to FIG. 2, the method of processing images of the paper ticket is disclosed. At step 1, the system receives the photo of the paper ticket and the scan of the barcode. The barcode may be included in the image as well. At step 2, an OCR result for each of the title of the event, venue, date, section and seat, as well as a confidence level as to the OCR result is assigned to the image. Factors that lead to the OCR confidence level are well known in the art of optical character recognition and image recognition. At step 3, if the confidence level is at least about 80%, then the process proceeds to step 5 where the digital information is combined with the barcode and the ticket is digitized to be a mobile ticket. If the confidence level is equal to or less than a predetermined required level of confidence, then the process proceeds to step 4. At step 4, the image and the OCR information is reviewed manually. Errors are corrected and a digital ticket is created. If the reviewer makes a determination based on the photo of the ticket that paper ticket is not valid, an error message is sent to the user to reimage the paper ticket.

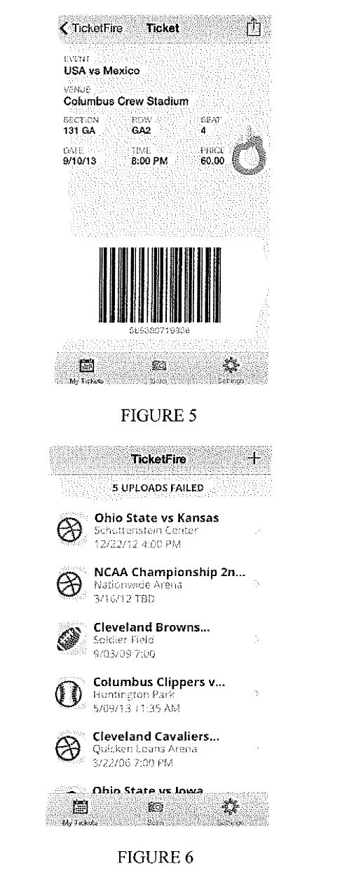

The controller processes the inputted information and provides an image of the digital ticket to the user. Upon completion of the process, a mobile ticket is created (FIG. 5). The controller assigns an identifier to each electronic ticket. In an embodiment, the controller assigns an icon to each ticket based on the type of event. In an embodiment, the icon is a symbol representing a particular sporting event, such as a ball or implement used in that sport, a music symbol, a theater symbol, and the like. Where a user has inputted multiple tickets, the controller provides a list of the electronic tickets to the user (FIG. 6) that comprises the icon, and information about the ticket. In an embodiment, the list is provided on a screen titled “My Tickets”. In an embodiment, the system stores information, searchable by the identifier, about each ticket in a database connected to the controller. In an embodiment, the digital ticket is stored on the device of the user.

The electronic ticket has a barcode that is displayed at the event to admit the owner. The barcode is readable by any barcode reader or scanner. The system creates an animation (such as but not limited to a flickering flame, a bouncing ball, a dancing musical note, and the like) on the electronic ticket to indicate that it is a live ticket and not a picture.

For season or multiple day tickets, the ticket can be used over and over until the expiration date or number of uses are exceeded.

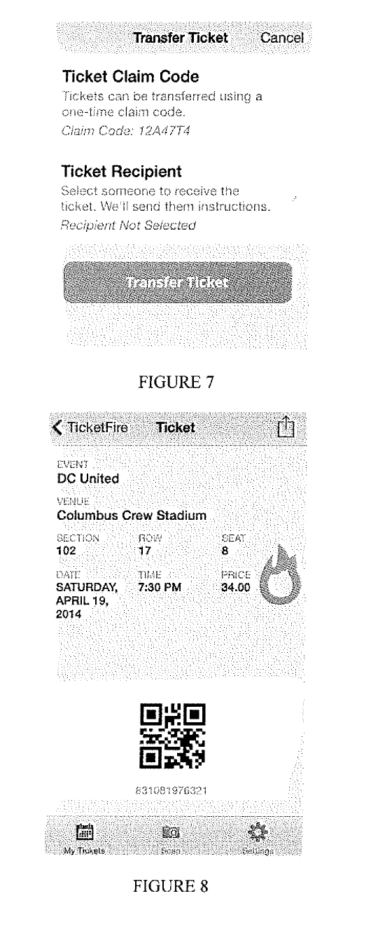

To transfer a ticket to a transferee, in an exemplary embodiment the user selects a ticket from the list depicted in the mobile app and then clicks a “share” button. The system prompts the user with a graphic of a menu via the app. The user selects “Transfer Ticket” from the menu. The system provides a graphic to the user to input the transferee information (FIG. 7). In an embodiment, the user selects a transferee from a person listed in the user's contacts on the device. In an embodiment, the user enters the name and mobile number of the transferee.

The system creates a claim code. The claim code is electronically sent in a notice to the transferee. In an embodiment, the notice is a text message. In an embodiment, the notice is transmitted in any electronic manner to a communication device, computer, tablet, smartphone (iPhone, Android), a kiosk and the like accessible by the transferee. The notice comprises information about the ticket, including but not limited to the identifier, sender, etc.; instructions on accessing the application; and the like.

The transferee downloads the app (if not already on the transferee's device), opens the app, and clicks a sign in a graphic generated by the system for the app. In an embodiment, the sign is a “+”. In an embodiment, the sign is a choice from a menu. The transferee selects “Claim Transfer” and pastes or retypes the claim code in the input field generated by the system.

The system matches the code to a pending ticket linked to the identifier in the system and securely transfers the ticket in electronic form to the transferee's device. In an embodiment, the system stores each electronic version of the ticket on the transferee's device (FIG. 8).

Before the ticket is claimed, the list on the owner's device provides a status as “pending.” At any time prior to being claimed, a transferred ticket is still viewable by the owner, but the bar code is not viewable by the owner/transferor, and the owner can cancel the transfer using the app. When the electronic ticket is claimed by the transferee, the electronic version of the ticket is removed from the owner's device and the system's database. When the ticket is claimed, the owner receives an electronic notice of the transfer, such as a confirmation email, text message or other electronic message sent to the user's email address or other suitable communications application. Where a user has multiple digitized tickets the controller removes the electronic listing of the ticket from the list and creates a record of the transfer for the user.

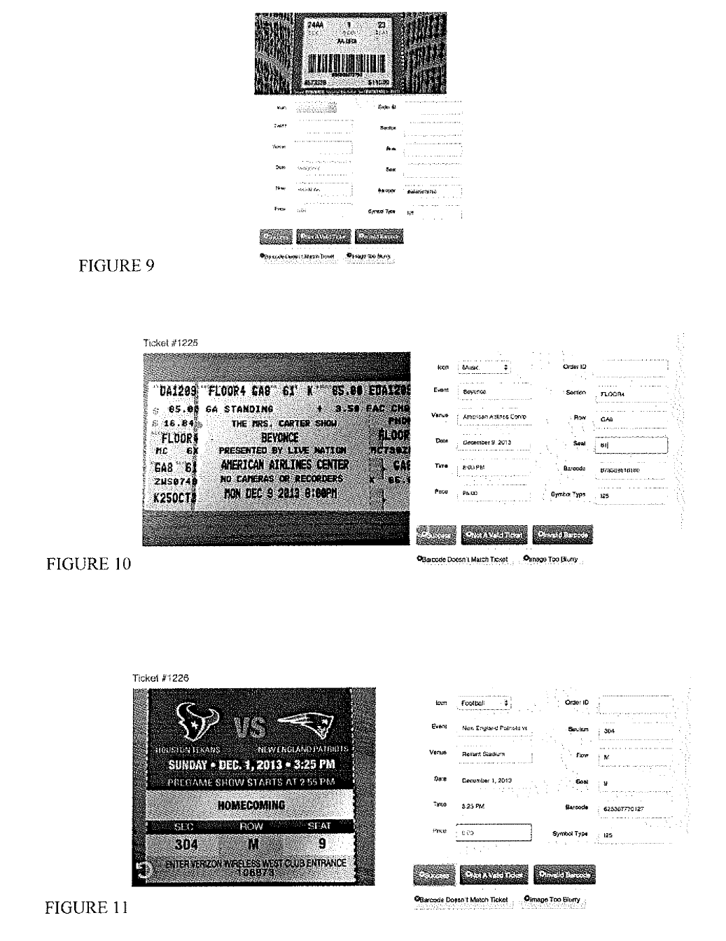

FIGS. 9-11 are examples of the technology that generate the digital ticket information. The invention comprises proprietary model files that the controller uses based on the origin of the ticket. The OCR technology uses parallel processes to digitize text. The OCR technology creates raw text, segments and lattice files corresponding to each line of the ticket to create a character model. The OCR technology creates a file containing the segmented characters and aligns each to a corresponding text file. The OCR technology comprises classifiers within the software, including but not limited to linear classifiers. The OCR technology compares the text file assuming that the document has an overall linear design, is composed of a similar fonts and is written in a single language. The OCR technology also comprises vertical and right to left character recognition and encoding for other languages.

As depicted in FIG. 9, the OCR technology converts text on the paper ticket and populates corresponding data fields (such as EVENT, VENUE, DATE, TIME, PRICE, SECTION, ROW, SEAT, and the like) in the system. The OCR technology searches the scanned object for matches to character strings such as the words (or part of the word): title, venue, date, time, price, section row and/or seat. The invention identifies the location of the matched character string to automatically identify and annotate text in an expected corresponding location. When a match to the character string is found, the match is used to find text on the ticket to populate a field associated with the matched character string. The system creates a matrix of boxes from the center of the matched character string that moves outward in all 4 directions (down, right, left, up) to capture expected values for that text. The system cancels out noise and artifacts. The captured values are selected based on an expected distance and direction from the matched character string, the type of ticket (for example, pdf vs. traditional) and the format of ticket. If not found within the given distance in the first direction, the system moves to a second direction. A minimum distance classifier is used to assign the right text to a field based on its distance from the matched character string. Boxes that contain only a connected component greater than about 20 pixels in area are captured and examined. In a preferred embodiment, boxes that contain only a connected component greater than about 40 pixels are captured.

For example, FIG. 10 depicts an example of the OCR technology searching a ticket for, among other character strings, the letters “SEC”. When located, the OCR system marks the location of the matched character string “SECTION” and creates the matrix of boxes around the word SECTION. In this example, the OCR technology firsts moves a given distance in the first direction from the located matched character string. The direction and the given distance are programmed based on the location and or appearance of the matched character string. As depicted in FIG. 10, the letters SEC are located at a given sector on the paper ticket. The OCR technology comprises a database of common ticket appearances that the system compares to the location of the located matched character string. The database comprises common given distances for such tickets, such as “touching the located matched character string” as well as directions, such as “below”. In this example, the OCR technology firsts searches immediately below the located matched character string. In an alternate embodiment, the given distance is determined based on the spacing of the located matched character string. In an alternate embodiment depicted in FIG. 11, the OCR technology is programmed to search for and capture expected values for text below the located matched character string at distance of about 1.5 the font size of the SEC.

As depicted in FIG. 10, the OCR technology populates the SECTION field with “FLOOR4”. As depicted in FIG. 11, the OCR technology populates the SECTION field with “304”. The system moves through each of the fields and inserts text in each of the fields based on the correlated matched character string.

FIG. 11 depicts a flagged conversion where no matched character string was located for PRICE. Other error messages requiring manual review include INVALID BARCODE, BARCODE DOES NOT MATCH TICKET and IMAGE TOO BLURRY. Upon an error message, the system flags the ticket and notifies the administrator for a manual review and input. The administrator reviews the flagged ticket, inputs the missing information and the electronic ticket is created. if the missing information cannot be corrected, notification is sent to the owner who can rescan the paper ticket.

The invention comprises the step of storing data. In an embodiment, a data storage device 110 is connected to the controller 100. The data storage device 110 is any mass storage device known in the art. In an embodiment, the data storage device 110 is suitably adapted to store user and transferee information, document data, image data, transfer codes linked to transferees, transferors and digital tickets, and the like, and to temporarily store image data, modified image data, barcode data and the like. In addition, the system updates the user's account history to reflect revised information and to enable the user to see transferred and untransferred mobile tickets and other suitable information. In an embodiment, the method is used to issue a digital ticket where an event is rescheduled or the venue is changed. The present invention allow transfer of tickets anywhere in the world where users and transferees are connected to the system.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Additional features of the invention will become apparent to those skilled in the art upon consideration of the description. Modifications may be made without departing from the spirit and scope of the invention.

I claim:

1. A method of creating a digital version of a paper ticket comprising the steps of:
a) receiving, at a controller connected to the Internet (i) a photo of the paper ticket and (iii) a scan of a barcode of the paper ticket;
b) processing the photo and scan, said processing comprising (i) using a unique optical character recognition (OCR) technology to create a result for each of an event title, a venue, a price, a date, a time, a section, a row and a seat, and (ii) determining a confidence level for the OCR results, wherein, if the confidence level is at least equal or greater than a predetermined confidence level, the OCR results are combined with the barcode and the ticket is digitized to create a mobile ticket, and if the confidence level is less than the predetermined confidence level, the photo and the OCR results are reviewed manually, errors are corrected and the digital ticket is created, or where errors cannot be corrected, a request to reimage the paper ticket is generated.

2. The method of claim 1 wherein the controller receives the photo and the scan via a mobile application from a smartphone.

3. The method of claim 1 wherein the digital ticket displays a barcode and an animation.

4. The method of claim 1 wherein the digital ticket is stored on a device.

5. The method of claim 1 wherein the digital ticket is one of a season and multiple use ticket.

6. The method of claim 1 further comprising the steps of transferring the digital ticket to a transferee.

7. The method of claim 6 wherein a claim code is electronically sent to a device of a transferee, and whereupon the controller receives an input of the claim code, the ticket is transferred to the device.

8. The method of claim 1 wherein the predetermined confidence level is about 90%.
